(19) United States
(12) Patent Application Publication
(10) Pub. No.: US 2018/0275834 A1
(43) Pub. Date: Sep. 27, 2018

(54) INFORMATION PROCESSING METHOD AND ELECTRONIC DEVICE

(71) Applicant: Lenovo (Beijing) Co., Ltd., Beijing (CN)

(72) Inventors: Cen YAO, Beijing (CN); Xi WAN, Beijing (CN); Qicheng DING, Beijing (CN)

(21) Appl. No.: 15/933,039

(22) Filed: Mar. 22, 2018

(30) Foreign Application Priority Data
Mar. 22, 2017 (CN) 201710177069.5

(51) Int. Cl. G06F 3/0481; G09G 5/14

(52) U.S. Cl. CPC G06F 3/0481; G09G 2354/00; G09G 5/14

(57) ABSTRACT

An information processing method and an electronic device are provided. The method includes: detecting, by a first electronic device, whether new information is received; in response to the new information being received, displaying a notification within a user's field of view within a display region of the first electronic device; and in response to a change in the user's field of view within the display region of the first electronic device, displaying the notification within a user's new field of view.

### CROSS-REFERENCES TO RELATED APPLICATIONS

This application claims priority to Chinese Patent Application No. 201710177069.5, filed on Mar. 22, 2017, the entire contents of which are hereby incorporated by reference.

### TECHNICAL FIELD

The present disclosure generally relates to the field of augmented reality (AR) technologies and, more particularly, to method and electronic device for information processing.

### BACKGROUND

As the augmented reality (AR) technology develops rapidly, the AR devices are more and more widely used. As an AR device is coupled to an electronic device, the AR device may be utilized to display a plurality of windows of the electronic device dispersedly in a space, which breaks the frame constraint on the physical screen. However, restricted by the field of view (FOV), the user of the AR device often cannot see all windows displayed in the space at the same time. Thus, the user of the AR device often cannot see status update or notification from each window.

### BRIEF SUMMARY OF THE DISCLOSURE

One aspect of the present disclosure provides an information processing method. The method includes: detecting, by a first electronic device, whether new information is received; in response to the new information being received, displaying a notification within a user's field of view within a display region of the first electronic device; and in response to a change in the user's field of view within the display region of the first electronic device, displaying the notification within a user's new field of view.

Another aspect of the present disclosure provides an electronic device. The electronic device includes a memory; and at least one processor, coupled with the memory. The memory is configured to store computer program instructions to implement an information processing method. In response to executing the computer program instructions, the at least one processor is configured to: detect whether new information is received; in response to the new information being received, display a notification within a user's field of view within a display region of the electronic device; and in response to a change in the user's field of view within the display region, display the notification within a user's new field of view.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 illustrates a taskbar for marking windows with new status or new notifications;

FIG. 2 illustrates a process flow chart of an information processing method consistent with some embodiments of the present disclosure;

FIG. 3 illustrates another process flow chart of an information processing method consistent with some embodiments of the present disclosure;

FIG. 4 illustrates another process flow chart of an information processing method consistent with some embodiments of the present disclosure;

FIG. 5 illustrates another process flow chart of an information processing method consistent with some embodiments of the present disclosure;

FIG. 6 illustrates a schematic view of a plurality of windows of a personal computer (PC) displayed by a pair of AR glass in space consistent with some embodiments of the present disclosure;

FIG. 7 illustrates another process flow chart of an information processing method consistent with some embodiments of the present disclosure;

FIG. 8 illustrates a schematic view of a display location of a control represented by a first sub-region with respect to a current display region consistent with some embodiments of the present disclosure;

FIG. 9 illustrates a schematic view of a relative distance from a display location of a control represented by a first sub-region to a current display region consistent with some embodiments of the present disclosure;

FIG. 10 illustrates another process flow chart of an information processing method consistent with some embodiments of the present disclosure;

FIG. 11 illustrates another schematic view of a display location of a control represented by a first sub-region with respect to a current display region consistent with some embodiments of the present disclosure;

FIG. 12 illustrates a schematic view showing that a display window of a control is awakened to a current display region consistent with some embodiments of the present disclosure;

FIG. 13 illustrates a schematic view of a relative distance from a display location of a control represented by a notification interface to a current display region consistent with some embodiments of the present disclosure; and

FIG. 14 illustrates a schematic view of a structure of an electronic device consistent with some embodiments of the present disclosure.

### DETAILED DESCRIPTION

Various aspects and features of the present disclosure will be described hereinafter with reference to the accompanying drawings. It should be understood that, various modifications may be made to the disclosed embodiments. Thus, the specification shall not be construed as limiting, but is merely intended to illustrate examples of the embodiments. Other modifications obtainable by those skilled in the relevant art shall all fall within the scope and spirit of the present disclosure.

Various embodiments of the present disclosure provide an information processing method and an electronic device.

For example, the information processing method may include detecting, whether new information is received; in response to the new information being received, displaying a notification within a user's field of view within a display region of the electronic device; and in response to a change in the user's field of view within the display region of the electronic device, displaying the notification within a user's new field of view. The electronic device may include a memory and at least one processor, coupled with the memory. The memory is configured to store computer program instructions for the at least one processor to implement an information processing method, by executing the computer program instructions.

In some embodiments, displaying the notification within the user's field of view within the display region includes determining whether a display location of a control corresponding to the new information is located within the user's field of view within the display region of the electronic device; and in response to the display location of the control corresponding to the new information being outside of the user's field of view within the display region of the electronic device, displaying the notification within the user's field of view within the display region of the electronic device.

In some embodiments, the method further includes receiving an input operation with respect to the notification; and based on the input operation, displaying detailed content corresponding to the new information within the user's field of view within the display region.

In some embodiments, displaying the notification within the user's field of view within the display region further includes: based on a relative position of the display location of the control corresponding to the new information with respect to the user's field of view within the display region, displaying a notification interface within a first sub-region within the user's field of view within the display region. The first sub-region indicates that the control is located at a first direction that matches the relative position.

In some embodiments, displaying the notification interface within the first sub-region further includes: displaying the notification interface along a side of the user's field of view within the display region that matches the first direction.

In some embodiments, displaying the notification interface within the first sub-region further includes: based on a relative distance between the display location of the control corresponding to the new information and the user's field of view within the display region, setting a dimension of the notification interface along the first direction.

In some embodiments, setting the dimension of the notification interface along the first direction includes: in response to the electronic device being detected to move along the first direction, reducing the dimension of the notification interface along the first direction.

In some embodiments, the method further includes: un-displaying the notification, in response to an input operation, with respect to the notification, un-received within a preset period of time.

In some embodiments, the method further includes: connecting the electronic device to another electronic device. The electronic device displays at least one interface of the another electronic device. In some embodiments, the electronic device is an augmented reality (AR) device.

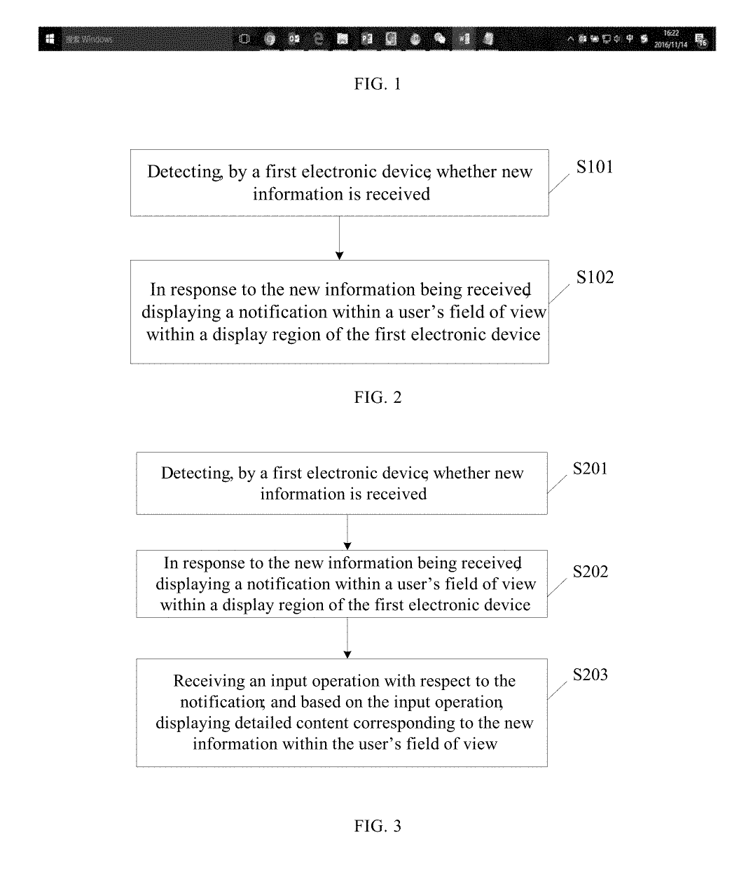

FIG. 1 illustrates a taskbar for displaying a plurality of icons, and the taskbar can often be found on an interface of an electronic device, where the electronic device may be a computer, tablet, or e-book, etc. As shown in FIG. 1, the plurality of icons may include one or more control icons representing corresponding control(s), such as Google Chrome, Outlook, Internet Explorer, Windows Explorer, PowerPoint, Evernote, Alitalk, Wechat, Word, and Notepad. A control herein may also be referred to as an “application control”. Once a control icon is clicked or pressed by a user, a corresponding window may be opened and displayed on the interface of the electronic device. Optionally, the user may open more than one window for the same control for display on the interface of the electronic device.

Optionally, the plurality of icons of the taskbar may further include system icons for displaying system information, such as the time and date, the input method in current use, and the remaining battery percentage. Once a system icon is clicked, a corresponding system program may be triggered to pop up a window of the system program, thereby showing detailed content and configuration options of related system information.

As a window of a control has an updated status or receives a notification, the background of the control icon corresponding to the control shown in the taskbar may have a changed color (e.g., red) to notify the user about the existence of updated status or notification. Other approaches may also be available to notify the user about the existence of updated status or notification, for example, the size of the control icon may be increased in response to a window of the corresponding control receiving a notification. However, the present disclosure is not limited thereto.

Further, an AR device may be connected to the electronic device, and the window(s) of control(s) displayed on the interface of the electronic device may be further displayed by the AR device on one or more of its display interfaces in space. A display interface of the AR device may be, for example, a virtual interface.

As the current display interface of the AR device is relative far from the interface of the electronic device that displays the taskbar, e.g., the user stands relatively far from the electronic device, the user that uses the AR device may not identify the background color of the control icons of the taskbar clearly, let alone noticing a change in the background color. Even if the user of the AR device happens to notice that the background color of a control icon in the taskbar changes, the location of the window of the corresponding control having an updated status or receiving a notification that is displayed by the AR device in space may not be identified or confirmed immediately.

The present disclosure provides an information processing method, applicable to a first electronic device. The first electronic device may be an augmented reality (AR) device, such as a head-mounted display device. The first electronic device may be coupled to a second electronic device, such as a personal computer (PC), wirelessly. The second electronic device may display a plurality of windows of control(s) on an interface (e.g., a display screen) thereof, and the first electronic device may be configured for displaying the plurality of windows of the control(s) on the interface of the second electronic device in different display locations in space.

FIG. 2 illustrates a process flow chart of an information processing method consistent with some embodiments of the present disclosure.

As shown in FIG. 2, the information processing method may include: detecting, by a first electronic device, whether new information is received (S101). For example, the first electronic device determines whether the new information is received through a wireless connection established between the first electronic device and the second electronic device. The new information may include new information in one or more windows of control(s) displayed on the second electronic device. Optionally, the new information may also include updated system information received by the second electronic device, such as the device status of the second electronic device or device status of any other device coupled to the second electronic device.

That is, the first electronic device may determine whether new information is received in a plurality of windows of the second electronic device that are displayed by the first electronic device in space via the wireless connection between the second electronic device and the first electronic device. The existence of the new information in one or more windows of the second electronic device may specifically refer to the existence of a status update of a running window of the second electronic device, and/or notification (e.g., message) received by the running window of the second electronic device. For example, the existence of new information in one or more windows of the second electronic device may include social controls such as Wechat or QQ receiving a message, or a page of a web client having an update, etc.

The information processing method may further include: in response to the new information being received, displaying a notification within a current display region of the first electronic device (S102).

In some embodiments, the current display region of the first electronic device may with respect to a user's “field of view” (FOV) within the display region of the first electronic device, which may be an observable region that a user can see through the first electronic device. For example, as the first electronic device is an AR device, the current display region of the AR device may be a spatial region defined by the sight of the user through the AR device.

Further, in response to a change in the user's field of view within the display region of the first electronic device (e.g., due to a change of the location of the first electronic device), the display region of the first electronic device may also change into a second display region. The second display region may be the display region of the first electronic device within the user's new field of view. The second display region (e.g., corresponding to the user's new field of view) may be totally or partially different from the current display region (e.g., corresponding to the user's field of view). That is, the second display region may not overlap with the current display region entirely.

For example, as the first electronic device detects that the new information is received, it means new information in a window of a control displayed on an interface of the second electronic device is detected, or updated system information of the second electronic device is detected, or a combination thereof.

In response to the updated system information of the second electronic device being detected, a notification may be displayed within the current display region of the first electronic device for a preset period of time. As a user clicks the notification within the preset period of time, an information box may be popped up displaying the detailed content of the updated system information. As the user does not click the notification within the preset period of time, the notification may disappear automatically. The notification may be, for example, a small icon with a pre-configured shape, such as a hollow five-pointed star. Further, the notification may be configured at an appropriate position within the current display region of the first electronic device. Such position of the notification may be pre-configured by the user, and may later be changed by the user.

In response to the new information in a window of a control displayed on the second electronic device being detected, the first electronic device may determine whether a display location of the control corresponding to the new information is located within the current display region of the first electronic device or not. The display location of the control corresponding to the new information herein may refer to a location of a display window of the control displayed by the first electronic device in space.

For example, as the display location of the control corresponding to the new information is determined to be within the current display region of the first electronic device, no processing is performed. As the display location of the control corresponding to the new information is determined not within the current display region of the first electronic device, the aforementioned notification (or a different identification) may be displayed within the current display region of the first electronic device. In one embodiment, the notification may be displayed within a first sub-region of the current display region of the first electronic device, the first sub-region may be a relatively small region of the current display region for indicating a first direction from the current display region to the display location of the control corresponding to the new information.

In one example, the first direction may be a direction from a center of the current display region to a center of the first sub-region. In another example, the first direction may be a direction from the center of the current display region to a center of the display location of the control corresponding to the new information. In another example, the first direction may be one of the four directions: right-to-left, left-to-right, up-to-down, and down-to-up, depending on whether the first sub-region is located within a left, right, lower, or upper region of the current display region of the first electronic device.

For example, in the case the first sub-region is displayed on the left side within the current display region, it is determined that the display location of the control corresponding to the new information is to the left of the current display region. In this example, the first direction may be a right-to-left direction.

As such, in response to the new information in a window of a control displayed on the second electronic device being detected, the notification may be displayed for notifying the existence of the new information. Further, the notification may provide a link to the control corresponding to the new information. For example, the notification may be triggered to display an interface of the control corresponding to the new information within the current display region.

In one embodiment, the first sub-region of the current display region may further display a notification interface, and the notification interface may be configured for indicating the relative position of the display location of the control corresponding to the new information with respect to the current display region. In one embodiment, the notification interface may be displayed on a first side region within the current display region that matches the first direction, thereby highlighting the relative positions of the display location of the control corresponding to the new information and of the current display region.

For example, in the case the notification interface is displayed on a left side region of the current display region, the display location of the control corresponding to the new information is determined to the left of the current display region. In this example, the first direction may be determined as a right-to-left direction.

Further, as the relative distance from the current display region of the first electronic device to the display location of the control corresponding to the new information changes, the width of the notification interface may change correspondingly. That is, the dimension of the notification interface may be relied on to determine the relative distance from the display location of the control corresponding to the new information to the current display region of the first electronic device.

For example, the first electronic device may move along the first direction. The relative distance from the current display region of the first electronic device to the display location of the control corresponding to the new information may thus be reduced, and the width of the notification interface may be correspondingly decreased. Or, the relative distance from the current display region of the first electronic device to the control corresponding to the new information may be increased, and the width of the notification interface may be increased correspondingly.

The present disclosure provides another information processing method, applicable to a first electronic device. The first electronic device may be an augmented reality (AR) device, such as a head-mounted display device. The first electronic device may be coupled to a second electronic device wirelessly. The second electronic device may be a personal computer (PC). Further, the first electronic device may display a plurality of windows of the PC in space.

FIG. 3 illustrates a process flow chart of an information processing method consistent with the present disclosure. As shown in FIG. 3, the information processing method may include: detecting, by a first electronic device, whether new information is received (S201). For example, the first electronic device determines whether new information is received in a plurality of windows of a PC displayed by the first electronic device in space via a wireless connection between the first electronic device and the PC. The existence of new information in the plurality of windows of the PC may refer to that one or more running windows showing status update. For example, the existence of the new information may include social controls such as Wechat or QQ displaying a notification, or a webpage displaying an update, etc.

The information processing method may further include: as the existence of new information is detected, displaying a notification within a current display region of the first electronic device (S202). For example, as the first electronic device detects that the new information is received, the first electronic device may further determine whether a display location of the control corresponding to the new information is located within a current display region (e.g., within a user's field of view within the display region of the first electronic device) of the first electronic device or not. As the display location of the control corresponding to the new information is determined to be within the current display region of the first electronic device, no processing is performed.

As the display location of the control corresponding to the new information is determined not within the current display region of the first electronic device, a notification is displayed within the current display region of the first electronic device. The notification is configured for notifying the existence of the new information.

In one example, as the first electronic device is the AR device, the current display region may be a spatial region defined by the viewing range of a person that uses the AR device. Further, as the location of the first electronic device changes, the display region of the first electronic device may also change and may be referred to as a second display region. The second display region may be totally or partially different from the current display region.

The current display region of the first electronic device may include a first sub-region, and the first sub-region may indicate a first direction from the current display region to the display location of the control corresponding to the new information. For example, in the case the first sub-region is located within the left side of the current display region, it is determined that the display location of the control corresponding to the new information is to the left of the current display region

The first sub-region of the current display region may display a notification interface, and the notification interface may be configured for notifying the relative position of the display location of the control with respect to the current display region. In one embodiment, the notification interface may be displayed on a first side of the current display region that matches the first direction. As the relative distance from the current display region of the first electronic device to the display region of the control corresponding to the new information changes, the width of the notification interface changes correspondingly. That is, the dimension of the notification interface may be applied to indicate the distance from the display location of the control corresponding to the new information to the current display region of the first electronic device.

For example, the first electronic device may move along the first direction. Thus, the relative distance from the current display region of the first electronic device to the display region of the control corresponding to the new information may become smaller, and the width of the notification interface becomes smaller. Or, the relative distance from the current display region with respect to the control corresponding to the new information may become longer, and the width of the notification interface may be increased correspondingly.

The information processing method may further include: receiving an input operation on the notification, and displaying detailed content corresponding to the new information within the current display region based on the input operation (S203). For example, as the first electronic device receives an input operation, such as a click or touch-control, on the notification, the detailed content corresponding to the new information is displayed within the current display region. That is, the detailed content corresponding to new information, such as the content of a newly received Wechat message or the page information of Tencent News, may be displayed within the current display region upon receiving the user operation on the notification.

As the first electronic device does not receive an input operation on the notification within a preset period of time, the notification and the notification interface may no longer be displayed. Optionally, the preset period of time may be configured based on actual needs and be adjusted by the user flexibly.

The present disclosure provides another information processing method, applicable to a first electronic device. The first electronic device may be an augmented reality (AR) device, such as a head-mounted display device. A plurality of controls may be installed in the first electronic device, and the plurality of controls may include: Wechat, QQ, Tencent news, and Youku video, etc. Further, the first electronic device may display one or more controls showing an activated status in space.

FIG. 4 illustrates a process flow chart of the information processing method consistent with the present disclosure. As shown in FIG. 4, the information processing method may include: detecting, by a first electronic device installed with a plurality of controls, whether new information is received (S301). For example, the first electronic device may determine whether new information is received in the plurality of controls by detecting an embedded control or application of the first electronic device.

The information processing method may further include: as the existence of the new information is detected, displaying a notification within a current display region of the first electronic device installed with the plurality of controls (S302). For example, as the first electronic device detects that the new information is received, the first electronic device may further determine whether a display location of the control corresponding to the new information is located within a current display region of the first electronic device or not. As the display location of the control corresponding to the new information is determined to be within the current display region of the first electronic device, no processing is performed.

As the display location of the control corresponding to the new information is determined not within the current display region of the first electronic device, a notification is displayed within the current display region of the first electronic device. The notification is configured for notifying the existence of the new information.

As the first electronic device is the AR device, the current display region may be a spatial region defined by the viewing range of the user through the AR device. As the location of the first electronic device changes, the display region of the first electronic device becomes a second display region, and the second display region may be totally or partially different from the current display region.

Further, the notification may be configured to provide a link to the control corresponding to the new information, and a first sub-region of the current display region may display a notification interface. The notification interface may be configured for notifying the relative position of the display location of the control with respect to the current display region. In one embodiment, the notification interface may be displayed on a first side region of the current display region that matches a first direction. The first sub-region indicates that the control corresponding to the new information is located along the first direction that matches the relative position. For example, in the case the first sub-region is located on the left side of the current display region, it is determined that the display location of the control corresponding to the new information is located to the left of the current display region.

As the relative distance from the current display region of the first electronic device to the display region of the control corresponding to the new information changes, the width of the notification interface changes correspondingly. That is, the dimension of the notification interface may be applied to determine the distance from the display location of the control corresponding to the new information to the current display region of the first electronic device.

The present disclosure provides another information processing method, applicable to a first electronic device. The first electronic device may be an augmented reality (AR) device, such as a head-mounted display device. A plurality of controls may be installed in the first electronic device, and the plurality of controls may include: Wechat, QQ, Tencent news, and Youku video, etc. Further, the first electronic device may display one or more controls showing an activated status in space.

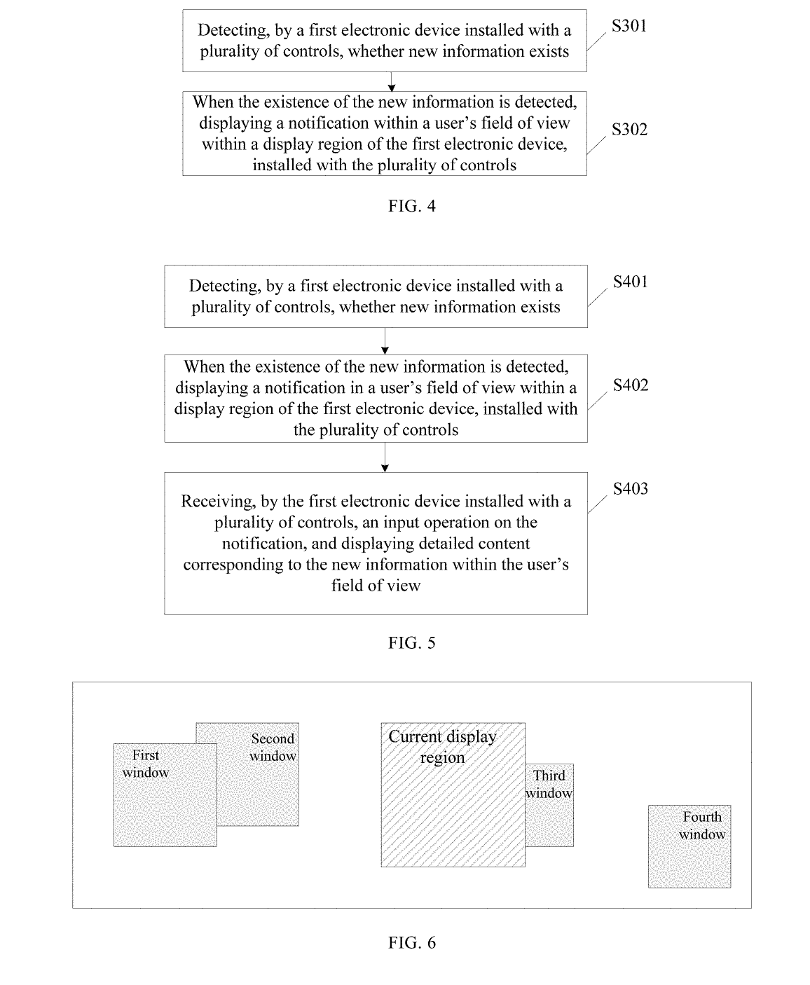

FIG. 5 illustrates a process flow chart of the information processing method consistent with the present disclosure. As shown in FIG. 5, the information processing method may include: detecting, by a first electronic device installed with a plurality of controls, whether new information is received (S401). For example, the first electronic device may determine whether new information is received in a control by detecting an embedded control of the first electronic device.

The information processing method may further include: as the existence of the new information is detected, displaying a notification within a current display region of the first electronic device installed with the plurality of controls (S402). For example, as the first electronic device detects that the new information is received, the first electronic device may further determine whether a display location of the control corresponding to the new information is located within a current display region of the first electronic device or not.

As the display location of the control corresponding to the new information is determined to be within the current display region of the first electronic device, no processing is performed. As the display location of the control corresponding to the new information is determined not within the current display region of the first electronic device, a notification is displayed within the current display region of the first electronic device. The notification is configured for notifying the existence of the new information.

As the first electronic device is the AR device, the current display region may be a spatial region indicated by the sight of the user of the AR device. As the location of the first electronic device changes, the display region of the first electronic device becomes a second display region, and the second display region may be totally or partially different from the current display region.

For example, the notification may be configured for providing a link to the control corresponding to the new information, and the first sub-region of the current display region may further display a notification interface. The notification interface may be configured for notifying the relative position of the display location of the control with respect to the current display region. Or, the notification interface may be displayed on a first side region of the current display region that matches a first direction. The first sub-region indicates that the control corresponding to the new information may be located along the first direction that matches the relative position. For example, in the case the first sub-region is located on the left side of the current display region, it is determined that the display location of the control corresponding to the new information is located to the left of the current display region.

As the relative distance from the current display region of the first electronic device to the display region of the control corresponding to the new information changes, the width of the notification interface changes correspondingly. That is, the dimension of the notification interface may be applied to determine the distance from the display location of the control corresponding to the new information to the current display region of the first electronic device.

For example, the first electronic device may move along the first direction. Thus, the relative distance from the current display region of the first electronic device to the control corresponding to the new information becomes smaller, the width of the notification interface becomes smaller. Or, the relative distance from the current display region to the control corresponding to the new information may become longer, and the width of the notification interface may increase correspondingly.

The information processing method may further include: receiving, by the first electronic device installed with the plurality of controls, an input operation on the notification, and displaying detailed content corresponding to the new information within the current display region based on the input operation (S403).

For example, as the first electronic device receives an input operation on the notification, such as a click or touch-control, the detailed content corresponding to the new information is displayed within the current display region. That is, the detailed content corresponding to new information, such as the message content of the Wechat or the page information of Tencent News, may be displayed within the current display region.

As the first electronic device does not receive an input operation on the notification within a preset period of time, the notification and the notification interface may disappear automatically. The preset period of time may be configured based on actual needs and be adjusted by the user flexibly.

The present disclosure further provides an information processing method. FIG. 6 shows a plurality of windows of a personal computer (PC) displayed by a pair of AR glass in space consistent with some embodiments of the present disclosure, thus providing an application scenario for illustrating the disclosed information processing method. As shown in FIG. 6, given the first electronic device being a pair of AR glasses, after the pair of AR glasses is connected to the PC wirelessly, a first window, a second window, a third window, and a fourth window of the PC may be displayed by the pair of AR glasses in space. A current display region may be a region denoted by the shaded region partially overlapping the third window, or may be a region adjacent to the third window.

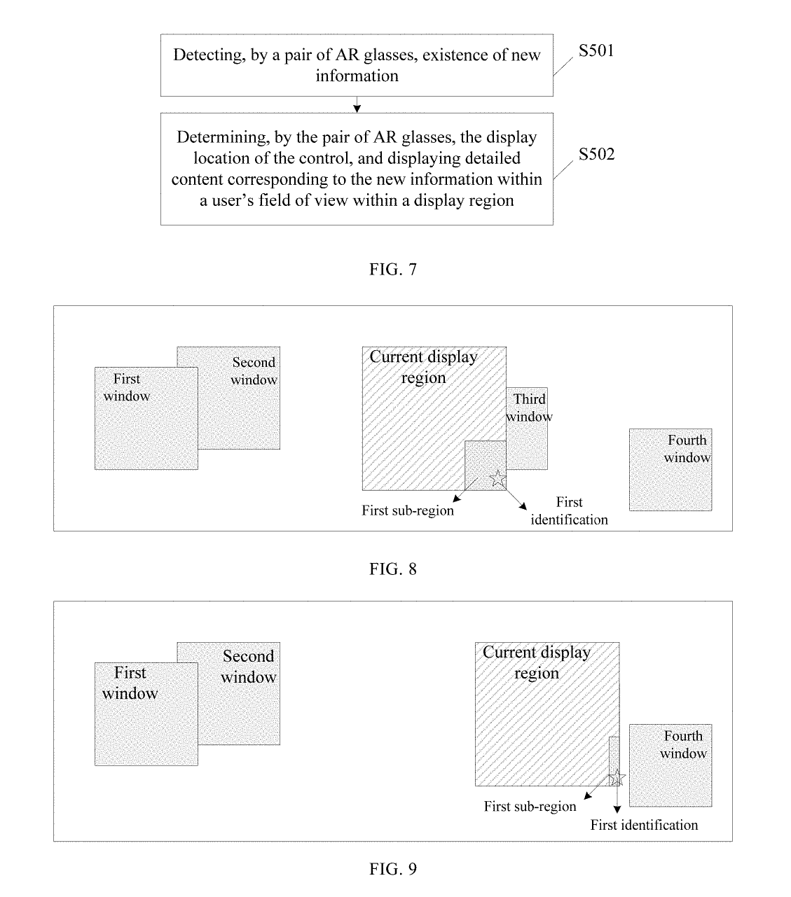

Based on FIG. 6, FIG. 7 illustrates a process flow chart of the information processing method consistent with the present disclosure. As shown in FIG. 7, The information processing method may include: as existence of new information is detected by a pair of AR glasses, displaying a notification within a current display region of the first electronic device (S501). For example, as the first electronic device detects that the new information is received, the first electronic device may further determine whether a display location of the control corresponding to the new information is located within a current display region of the first electronic device or not.

As the display location of the control corresponding to the new information is determined to be within the current display region of the first electronic device, no processing is performed. As the display location of the control corresponding to the new information is determined not within the current display region of the first electronic device, the notification is displayed within the current display region of the first electronic device. The notification is configured for providing a link to the control corresponding to the new information.

In one embodiment, as the display location of the control corresponding to the new information is determined not within the current display region of the pair of AR glasses, the notification is displayed within a first sub-region of the current display region of the pair of AR glasses. The first sub-region is within the current display region, and the area of the first sub-region is smaller than the area of the current display region. The shape of the first sub-region may be square, circular, rectangular, etc.

Further, other than being configured for displaying the notification, the first sub-region may be configured for notifying the relative position of the display location of the control corresponding to the new information with respect to the current display region. FIG. 8 illustrates a schematic view of a first sub-region indicating the relative position of a display location of a control corresponding to the new information with respect to a current display region consistent with the present disclosure. As shown in FIG. 8, the first sub-region is on the right side of the current display region, thus indicating the display location of the control corresponding to the new information is to the right of the current display region, or partially to the right of the current display region (i.e., partially overlapping the right-side region of the current display region).

That is, the display location of the control corresponding to the new information may be located horizontally to the right of the current display region. For example, the third window or the fourth window to the right of the current display region may be a display window of the control corresponding to the new information.

Correspondingly, the dimension of the first sub-region along the horizontal direction may be applied to indicate the relative distance from the display location of the control to the current display region. The relative distance herein may refer to a horizontal distance from the center of the display location of the control to the center of the current display region, or a horizontal distance between two vertical sides of the current display region and the display location of the control showing the minimum distance. Various other approaches for calculation of the relative distance may also be possible, and the present disclosure is not limited thereto.

For example, as shown in FIG. 8, in the case the fourth window to the right of the current display region is the display window of the control corresponding to the new information, the dimension of the first sub-region along the horizontal direction may be relatively long. In the case the third window to the right of the current display region is the display window of the control corresponding to the new information, the dimension of the first sub-region along the horizontal direction may be relatively short.

The information processing method may further include: determining, by the pair of AR glasses, the display location of the control, and displaying detailed content corresponding to the new information in the current display region (S502). For example, referring to FIG. 8, based on the display location of the control corresponding to the new information indicated by the first sub-region, the current display region of the pair of AR glasses may be controlled to move rightwards until the display location of the control is determined. Further, the click operation on the notification may be received, and based on the click operation, the detailed content corresponding to the new information may be displayed within the current display region.

For example, FIG. 9 illustrates a schematic view of a relative distance from a display location of a control indicated by a first sub-region to a current display region consistent with some embodiments of the present disclosure. Referring to FIG. 9, as the current display region of the pair of AR glasses move rightwards, the width of the first sub-region decreases gradually, indicating that the relative distance from the display location of the control to the current display region decreases gradually.

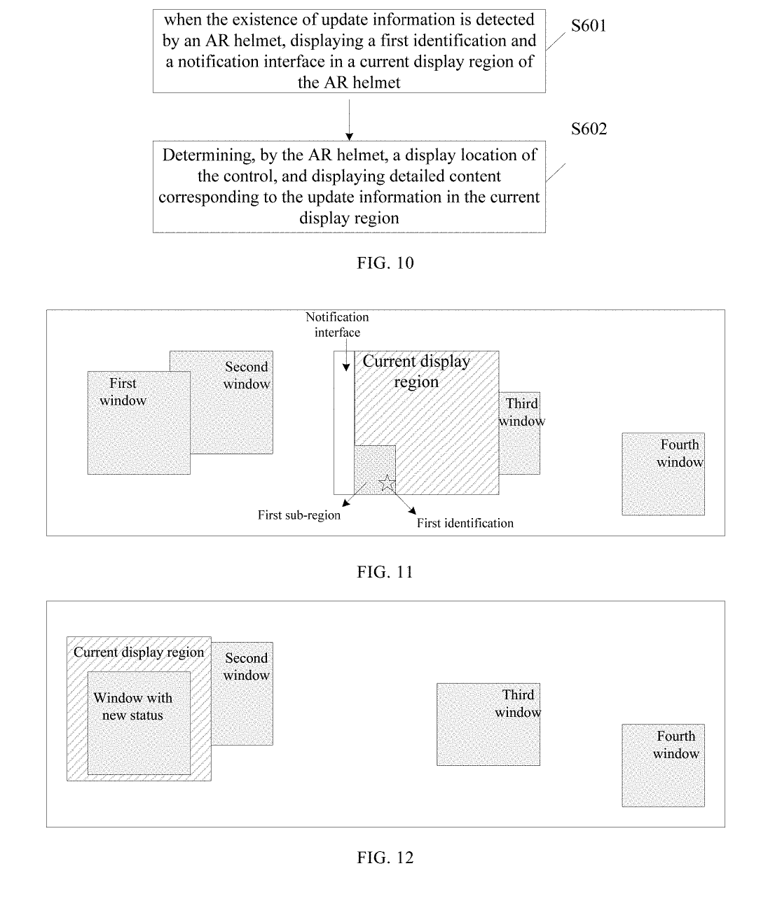

The present disclosure further provides another information processing method. Given the first electronic device being an AR helmet, after the AR helmet is connected to the PC wirelessly, a plurality of windows of the PC may be displayed by the AR helmet in space. FIG. 10 illustrates a process flow chart of the information processing method consistent with some embodiments of the present disclosure. As shown in FIG. 10, the method may include: as the existence of new information is detected by an AR helmet, displaying a notification and a notification interface within a current display region of the AR helmet (S601).

For example, as the AR helmet detects that the new information is received, the AR helmet may further determine whether a display location of the control corresponding to the new information is located within a current display region of the AR helmet or not. As the display location of the control corresponding to the new information is determined to be within the current display region of the AR helmet, no processing is performed.

As the display location of the control corresponding to the new information is determined not within the current display region of the AR helmet, a notification may be displayed within the current display region of the AR helmet. The notification is configured for providing a link to the control corresponding to the new information.

In one embodiment, as the display location of the control corresponding to the new information is determined not within the current display region of the AR helmet, a first sub-region of the current display region of the AR helmet may display the notification, and a notification interface may be further displayed in the first sub-region. Optionally, the notification interface may not be displayed within the first sub-region, but be adjacent to the first sub-region.

Further, the width of the notification interface may be configured for notifying the relative distance from the display location of the control to the current display region. The first sub-region is within the current display region, and the area of the first sub-region is smaller than the area of the current display region.

As an example, FIG. 11 illustrates a schematic view of a display location of a control represented by a first sub-region with respect to a current display region consistent with the present disclosure. As shown in FIG. 11, the notification may be displayed within the first sub-region belonging to a left portion of the current display region, and the notification interface may be displayed covering the left edge of the current display region and be adjacent to the first sub-region. Thus, the display location of the control corresponding to the new information is notified by the first sub-region or the notification interface within the left side of the current display region.

The information processing method may further include: determining, by the AR helmet, a display location of the control, and displaying detailed content corresponding to the new information within the current display region (S602). For example, based on the notification of the first sub-region, the current display region of the AR helmet may be controlled to move leftwards until the display location of the control is determined.

Further, a touch-control operation on the notification may be received. Based on the touch-control operation, the detailed content corresponding to the new information may be displayed within the current display region. That is, the display window of the control may be awakened to be within the current display region, as shown in FIG. 12, where a display window of the control having a new status (e.g., first window) is awakened to be within a current display region.

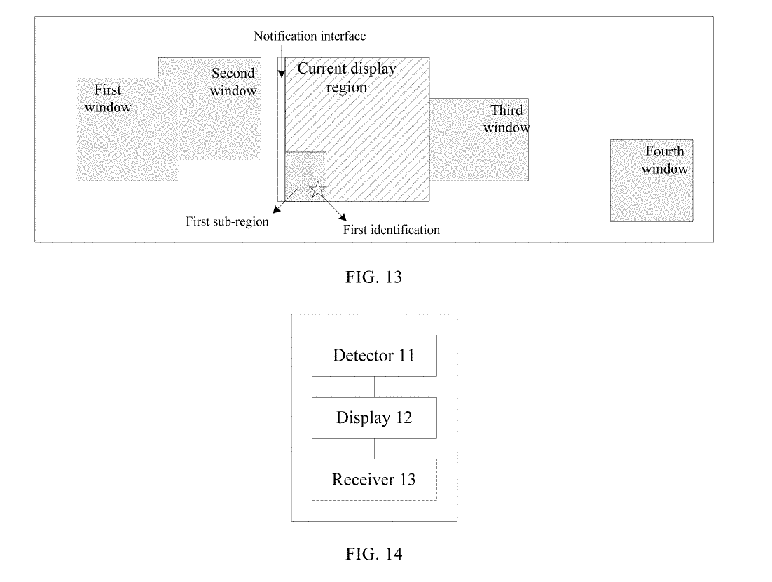

FIG. 13 illustrates a schematic view of a relative distance from a display location of a control represented by a notification interface to a current display region consistent with the present disclosure. As shown in FIG. 13, as the current display region of the AR helmet move leftwards, the width of the notification interface decreases gradually, indicating that the relative distance from the display location of the control to the current display region decreases gradually.

To implement the aforementioned information processing method, the present disclosure further provides an electronic device. FIG. 14 illustrates a schematic view of a structure of an electronic device consistent with the present disclosure. As shown in FIG. 14, the electronic device may include a detector 11, and a display 12. Optionally, the electronic device may further include a receiver 13. As the location of the electronic device changes, the current display region of the electronic device becomes a second display region, and the second display region may be totally or partially different from the current display region.

The detector 11 may be configured for detecting whether new information is received. The display 12 may be configured for, as the detector 11 detects that the new information is received, displaying a notification within a current display region of the electronic device. The notification is configured for notifying the existence of the new information. The receiver 13 may be configured for receiving an input operation on the notification, and triggering the display 12 to display detailed content corresponding to the new information within the current display region.

For example, the display 12 may be specifically configured for determining whether the display location of the control corresponding to the new information is located within the current display region of the first electronic device. As the display location of the control corresponding to the new information is determined not within the current display region of the first electronic device, the notification is displayed within the current display region of the electronic device.

In one embodiment, as the receiving unit 13 does not receive the input operation on the notification within a preset period of time, the display 12 may not be triggered, and the display 12 may not display the notification.

In one embodiment, the display 12 is specifically configured for, based on the relative position of the display location of the control corresponding to the new information with respect to the current display region, displaying a notification interface within the first sub-region of the current display region. The first sub-region indicates that a display location of the control corresponding to the new information is located along a first direction that matches the relative position. The first direction herein may refer to a direction from the current display region to the display location of the control corresponding to the new information, thereby matching the relative position.

For example, in the case the first sub-region is located on the left side of the current display region, it is determined that the display location of the control corresponding to the new information is located to the left of the current display region. Further, the dimension of the notification interface may be applied to determine the relative distance from the display location of the control corresponding to the new information to the current display region.

In one embodiment, the display 12 may be specifically configured for displaying the notification interface on a first side of the current display region that matches the first direction. For example, in the case the display location of the control corresponding to the new information is horizontally to the right of the current display region, the notification interface may be displayed within the right side of the first sub-region.

In one embodiment, the display 12 may be specifically configured for, based on the relative distance from the display location of the control corresponding to the new information to the current display region, configuring a dimension (e.g., width) of the notification interface. As the relative distance from the current display region of the first electronic device to control corresponding to the new information becomes smaller, the corresponding dimension (e.g., the width) of the notification interface becomes smaller. Optionally, the relative distance from the current display region with respect to the control corresponding to the new information may become longer, and the corresponding dimension of the notification interface may be increased correspondingly.

In one embodiment, the display 12 may be specifically configured for decreasing or increasing the dimension of the notification interface as the electronic device is detected to move along the first direction.

The electronic device may be an AR device, such as a head-mounted display device. The AR device may be connected to the PC wirelessly, and the AR device may display a plurality of windows of the PC in space. Or, the AR device may be installed with a plurality of controls. The plurality of controls may include: Wechat, QQ, Tencent News, Youku video, etc. Further, the AR device may display one or more controls showing an activated status in space.

Further, the detector 11, the display 12, and the receiver 13 included in the electronic device may be implemented by a central processing unit (CPU), a micro-processing unit (MPU), a digital signal processing unit (DSP), or a field-programmable gate array (FPGA), etc. The aforementioned functions of the detector 11, the display 12, and the receiver 13 may be implemented by program codes executable by one or more processing units, such as the CPU, MPU, DSP, or FPGA, etc. Further, the program codes may be stored in a memory.

Those ordinarily skilled in the relevant art may understand that all or partial of the aforementioned method embodiments may be implemented via firmware related to program instructions, and the programs may be stored in a computer-readable unit. As the programs are executed, the aforementioned method embodiments may be executed. Various types of media for storing program instructions, such as a portable storage device, a Read-only memory (ROM), a random access memory (RAM), a magnetic disc, or an optic disc, may be applied as the storage unit.

Or, as the described functions are implemented as software function units, and are sold or used as independent products, they may be stored in a computer accessible storage medium. Based on such understanding, the technical solutions of the present disclosure, or the portions contributing to the prior art may be embodied in the form of a software product. The computer software product may be stored in a storage medium, and include several instructions to instruct a computer device (e.g., a personal computer, a server, or a network device) to execute all or some of the method steps of each embodiment. The storage medium described above may include portable storage device, ROM, RAM, a magnetic disc, an optical disc or any other media that may store program codes.

The foregoing is only specific implementation methods of the present disclosure, and the protection scope of the present disclosure is not limited thereto. Without departing from the technical scope of the present disclosure, variations or replacements obtainable by anyone skilled in the relevant art shall all fall within the protection scope of the present disclosure. The protection scope of the subject disclosure is therefore to be limited only by the scope of the appended claims.

What is claimed is:

1. An information processing method, comprising:
detecting, by a first electronic device, whether new information is received;
in response to the new information being received, displaying a notification within a user's field of view within a display region of the first electronic device; and
in response to a change in the user's field of view within the display region of the first electronic device, displaying the notification within a user's new field of view.

2. The method according to claim 1, wherein in response to the new information being received, displaying the notification within the user's field of view within the display region of the first electronic device comprises:
determining whether a display location of a control corresponding to the new information is located within the user's field of view within the display region of the first electronic device; and
in response to the display location of the control corresponding to the new information being outside of the user's field of view within the display region of the first electronic device, displaying the notification within the user's field of view within the display region of the first electronic device.

3. The method according to claim 1, further comprising:
receiving an input operation with respect to the notification; and
based on the input operation, displaying detailed content corresponding to the new information within the user's field of view within the display region.

4. The method according to claim 2, wherein displaying the notification within the user's field of view within the display region of the first electronic device further comprises:
based on a relative position of the display location of the control corresponding to the new information with respect to the user's field of view within the display region, displaying a notification interface within a first sub-region within the user's field of view within the display region,
wherein the first sub-region indicates that the control is located at a first direction that matches the relative position.

5. The method according to claim 4, wherein displaying the notification interface within the first sub-region further comprises:
displaying the notification interface along a side of the user's field of view within the display region that matches the first direction.

6. The method according to claim 4, wherein displaying the notification interface within the first sub-region further comprises:
based on a relative distance between the display location of the control corresponding to the new information and the user's field of view within the display region, setting a dimension of the notification interface along the first direction.

7. The method according to claim 6, wherein setting the dimension of the notification interface along the first direction comprises:
in response to the first electronic device being detected to move along the first direction, reducing the dimension of the notification interface along the first direction.

8. The method according to claim 1, further comprising:
un-displaying the notification, in response to an input operation, with respect to the notification, un-received within a preset period of time.

9. The method according to claim 1, further comprising:
connecting the first electronic device to a second electronic device,
wherein the first electronic device displays at least one interface of the second electronic device.

10. The method according to claim 1, wherein:
the first electronic device is an augmented reality (AR) device.

11. An electronic device, comprising:
a memory; and
at least one processor, coupled with the memory, wherein:
the memory is configured to store computer program instructions to implement an information processing method, and
in response to executing the computer program instructions, the at least one processor being configured to:
detect whether new information is received;
in response to the new information being received, display a notification within a user's field of view within a display region of the electronic device; and
in response to a change in the user's field of view within the display region, display the notification within a user's new field of view.

12. The electronic device according to claim 11, wherein the at least one processor is configured to:
determine whether a display location of the control corresponding to the new information is located within the user's field of view within the display region of the electronic device; and
in response to the display location of the control corresponding to the new information outside of the user's field of view within the display region of the electronic device, display the notification within the user's field of view within the display region of the first electronic device.

13. The electronic device according to claim 11, wherein the at least one processor is further configured to:
receive an input operation with respect to the notification, and
based on the input operation, trigger displaying detailed content corresponding to the new information within the user's field of view within the display region.

14. The electronic device according to claim 11, further including a display, wherein:
based on a relative position of a display location of a control corresponding to the new information with respect to the user's field of view within the display region, the display is configured to display a notification interface within a first sub-region within the user's field of view within the display region, and
the first sub-region indicates that the control is located at a first direction that matches the relative position.

15. The electronic device according to claim 14, wherein:
the display is configured to display the notification interface along a side of the user's field of view within the display region that matches the first direction.

16. The electronic device according to claim 14, wherein:
based on a relative distance between the display location of the control corresponding to the new information and the user's field of view within the display region, the display is configured to set a dimension of the notification interface along the first direction.

17. The electronic device according to claim 16, wherein:
the display is configured to reduce the dimension of the notification interface along the first direction in response to the electronic device being detected to move along the first direction.

18. The electronic device according to claim 11, further including a display, wherein:
the display is configured not to display the notification, in response to the input operation, with respect to the notification, un-received within a preset period of time.

19. The electronic device according to claim 11, wherein:
the electronic device is connected to another electronic device to display at least one interface of the another electronic device.

20. The electronic device according to claim 19, wherein:
the electronic device is an augmented reality (AR) device.
